(19) United States
(12) Patent Application Publication
(10) Pub. No.: US 2002/0053660 A1
(43) Pub. Date: May 9, 2002

(54) Glow-in-the-dark texture solution composition

(76) Inventor: Hector Gomez, Garden Grove, CA (US)

Correspondence Address: Matthew J. Peirce, Esq., 1550 Starlight Canyon Avenue, Las Vegas, NV, 89123, US

(21) Appl. No.: 10/008,659

(22) Filed: Nov. 3, 2001

Related U.S. Application Data
(60) Provisional application No. 60/245,349, filed on Nov. 3, 2000.

(51) Int. Cl. C09K 11/02; C04B 14/00; C04B 16/00; C04B 24/00

(52) U.S. Cl. 252/301.36; 106/712

(57) ABSTRACT

A new and improved texture solution composition is disclosed that would be applied to decorative rock, concrete, lithocrete, and tile. Applying the texture solution to decorative rock, concrete, lithocrete and tile surfaces would add a distinct “glow-in-the-dark” characteristic to them. These surfaces with this texture solution applied would have the quality of phosphorescence, and would glow minutes after being exposed to bright light. In addition, the solution would glow when “black light” is shown on it.

### I. BACKGROUND OF THE INVENTION

The present invention is that of a new and improved texture solution that would be applied to decorative rock, concrete, lithocrete, and tile.

### II. DESCRIPTION OF THE PRIOR ART

U.S. Pat. No. 5,849,218, issued to Johansen, Jr., et al., discloses an outer or top coating for water retention structures that comprises a water insoluble fluorescent compound that is invisible to the human eye under normal lighting conditions but which will fluoresce or glow and be visible to the human eye when illuminated with an ultraviolet or infrared radiation source.

U.S. Pat. No. 5,558,708, issued to Johansen, Jr., et al., discloses a system and method for dispersing pigment in cement based compositions comprising a predetermined and prepackaged amount of a cement based component and a predetermined and prepackaged amount of an aqueous dispersion of a pigment containing component.

U.S. Pat. No. 5,314,536, issued to Kawasaki, discloses a method of making a construction material luminous in response to ultraviolet rays.

### III. SUMMARY OF THE INVENTION

The present invention is that of a new and improved texture solution that would be applied to decorative rock, concrete, lithocrete, and tile. Applying the texture solution to decorative rock, concrete, lithocrete and tile surfaces would add a distinct “glow-in-the-dark” characteristic to them. These surfaces with this texture solution applied would have the quality of phosphorescence, and would glow minutes after being exposed to bright light. In addition, the solution would glow when “black light” is shown on it.

There has thus been outlined, rather broadly, the more important features of a texture solution that glows in the dark in order that the detailed description thereof that follows may be better understood and in order that the present contribution to the art may be better appreciated. There are, of course, additional features of the texture solution that glows in the dark that will be described hereinafter and which will form the subject matter of the claims appended hereto.

In this respect, before explaining at least one embodiment of the texture solution that glows in the dark in detail, it is to be understood that the texture solution that glows in the dark is not limited in its application to the details of construction and to the arrangements of the components set forth in the following description or illustrated in the drawings. The texture solution that glows in the dark is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present texture solution that glows in the dark. It is important, therefore, that the claims be regard as including such equivalent constructions insofar as they do not depart from the spirit and scope of the present invention.

It is therefore an object of the present invention to provide a texture solution that glows in the dark which has all of the advantages of the prior art and none of the disadvantages.

It is another object of the present invention to provide a texture solution that glows in the dark which may be easily and efficiently manufactured and marketed.

It is another object of the present invention to provide a texture solution that glows in the dark which is of durable and reliable construction.

It is yet another object of the present invention to provide a texture solution that glows in the dark which is economically affordable and available to the buying public.

It is yet another object of the present invention to provide a texture solution that glows in the dark which provides additional benefits not present in the prior art.

Other objects, features and advantages of the present invention will become more readily apparent from the following detailed description of the preferred embodiment when considered with the attached drawings and appended claims.

### IV. DESCRIPTION OF THE PREFERRED EMBODIMENT

The formula for the texture solution would be as follows:

Glow Green Fluorescent Pigment (glow-in-the-dark paint), 30 ounces.

Water, 30 ounces

Deck-O-Weld (concrete adhesive), 10 ounces

Styling Hair Gel, 10 ounces

Combining and mixing the above ingredients in the above-listed proportions yields a proper solution that will adhere to concrete or a similar surface, and therefore allow it to glow in the dark. A user would be able to apply the texture solution as desired in order to achieve a “glow-in-the-dark” or phosphorescent characteristic on their desired lithocrete, concrete, tile, or decorative rock surfaces.

The above texture solution, once made and applied to an exterior surface, would carry a soft glow after a nominal illumination time, making it useful for dusk or twilight landscaping and structural effects. Used in driveways and walkways, the present invention would offer illuminated pathways that help individuals be assured of level footing while making their way into a home after dark, thus reducing the possibility of injury in dim lighting conditions.

What I claim as my invention is:

1. A texture solution for application on to a surface comprising:
(a) 30 ounces of green fluorescent pigment,
(b) 30 ounces of water,
(c) 10 ounces of concrete adhesive, and
(d) 10 ounces of styling hair gel.

2. A texture solution for application on to a surface according to claim 1 wherein the green fluorescent pigment would be the Glow Green Fluorescent Pigment brand.

3. A texture solution for application on to a surface according to claim 1 wherein the concrete adhesive would be the Deck-O-Weld brand.

4. A process of making a texture solution comprising the steps of:
(a) placing 30 ounces of water in a container,
(b) adding 30 ounces of green fluorescent pigment,
(c) adding 10 ounces of concrete adhesive,
(d) adding 10 ounces of styling hair gel,
(e) mixing the resulting solution, and
(f) applying the resulting solution on to an exterior surface.

5. A process of making a texture solution according to claim 4 wherein the green fluorescent pigment would be the Glow Green Fluorescent Pigment brand.

6. A process of making a texture solution according to claim 4 wherein the concrete adhesive would be the Deck-O-Weld brand.

7. A process of making a texture solution according to claim 4 wherein the exterior surface would be lithocrete.

8. A process of making a texture solution according to claim 4 wherein the exterior surface would be concrete.

9. A process of making a texture solution according to claim 4 wherein the exterior surface would be tile.

10. A process of making a texture solution according to claim 4 wherein the exterior surface would be a decorative rock surface.
